(19) United States
(12) Patent Application Publication
(10) Pub. No.: US 2026/0170518 A1
(43) Pub. Date: Jun. 18, 2026

(54) SYSTEM AND METHOD FOR QUANTIFYING GROWTH DRIVERS OF NICHE CATEGORIES

(71) Applicant: Cogitaas AVA Pte Ltd, Singapore (SG)

(72) Inventors: Sree Kamal Sen, Mumbai (IN); Balaji Raman, Mumbai (IN)

(21) Appl. No.: 18/981,738

(22) Filed: Dec. 16, 2024

(51) Int. Cl. G06Q 30/0202; G06Q 30/0204

(52) U.S. Cl. CPC G06Q 30/0202; G06Q 30/0204

(57) ABSTRACT

The present disclosure provides a system for quantifying drivers of growth of niche categories. The system includes a data collection module configured to receive consumer data collected using surveys, an analysis module configured to identify consumer segments using factor analysis of the received consumer data, a market size estimation module configured to estimate market size for each identified consumer segment based on current consumption, a demographic categorization module configured to create sub-groups based on demographics, a growth potential determination module configured to determine growth potential by regressing consumption behavior on the identified consumer segments and consumer demographics using multinomial regression, and a market size prediction module configured to predict potential market size based on model weights and predicted probability of switching between consumer classes.

### FIELD OF INVENTION

The present disclosure relates to market analysis systems and methods, and more particularly to a system and method for quantifying drivers of growth of niche categories through a Market Emergence Model.

### BACKGROUND

Many product categories, despite having significant growth potential, often struggle to reach even a fraction of their market potential. This is frequently due to a lack of deep understanding of target consumers and the factors that drive their purchasing decisions. Traditional market research methods may provide surface-level insights, but often fail to uncover the complex interplay of attitudes, behaviors, and demographics that truly influence category adoption and growth.

In rapidly evolving markets, brands and marketers face challenges in identifying and quantifying the key drivers that can unlock disruptive growth for niche or emerging product categories. Without a clear understanding of these drivers, companies may misallocate resources or miss critical opportunities to expand their consumer base and market share.

Furthermore, the ability to segment consumers based on their attitudes, behaviors, and likelihood of category adoption is crucial for developing targeted marketing strategies. However, existing segmentation approaches may not adequately capture the nuanced differences between consumer groups or provide actionable insights for driving growth across different segments.

There is a need for more sophisticated analytical tools and methodologies that can provide a comprehensive understanding of category growth potential, identify key growth drivers, and quantify the impact of activating these drivers across different consumer segments and geographical clusters. Such tools could enable brands to make more informed decisions about product development, marketing strategies, and resource allocation to maximize growth potential in niche or emerging categories.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for quantifying drivers of growth of niche categories through a Market Emergence Model is provided. The system includes a data collection module configured to receive consumer data collected using a carefully designed survey. The system also includes an analysis module configured to identify consumer segments using factor analysis of the received consumer data. The system further includes a market size estimation module configured to estimate market size for each identified consumer segment based on current consumption. Additionally, the system includes a demographic categorization module configured to create sub-groups based on demographics. The system also includes a growth potential determination module configured to determine growth potential by regressing consumption behavior on the identified consumer segments and consumer demographics using multinomial regression. Finally, the system includes a market size prediction module configured to predict potential market size based on model weights or coefficients and predicted probability of switching from one consumer class to another.

According to other aspects of the present disclosure, the system may include one or more of the following features. The carefully designed survey may collect details on demographics, socio-economic status, consumption behavior, category perception, general psychographics, and functional and emotional needs related to the category. The factor analysis may identify different consumer segments based on attitudes, functional needs, and emotional needs. The sub-groups based on demographics may be created using a combination of age, city, and gender. The multinomial regression may use the identified consumer segments and demographics as independent variables and consumption behavior as the dependent variable. The predicted probability of switching from one consumer class to another may be computed using the coefficients from the multinomial regression model.

According to another aspect of the present disclosure, a method for quantifying drivers of growth of niche categories through a Market Emergence Model is provided. The method includes receiving consumer data collected using a carefully designed survey. The method also includes identifying consumer segments using factor analysis of the received consumer data. The method further includes estimating market size for each identified consumer segment based on current consumption. Additionally, the method includes creating sub-groups based on demographics. The method also includes determining growth potential by regressing consumption behavior on the identified consumer segments and consumer demographics using multinomial regression. Finally, the method includes predicting potential market size based on model weights or coefficients and predicted probability of switching from one consumer class to another.

According to other aspects of the present disclosure, the method may include one or more of the following features. The carefully designed survey may collect details on demographics, socio-economic status, consumption behavior, category perception, general psychographics, and functional and emotional needs related to the category. The factor analysis may identify different consumer segments based on attitudes, functional needs, and emotional needs. The sub-groups based on demographics may be created using a combination of age, city, and gender. The multinomial regression may use the identified consumer segments and demographics as independent variables and consumption behavior as the dependent variable. The predicted probability of switching from one consumer class to another may be computed using the coefficients from the multinomial regression model.

The foregoing general description of the illustrative embodiments and the following detailed description thereof are merely exemplary aspects of the teachings of this disclosure and are not restrictive.

### BRIEF DESCRIPTION OF DRAWINGS

The foregoing general description of the illustrative embodiments and the following detailed description thereof are merely exemplary aspects of the teachings of this disclosure and are not restrictive.

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of the system for a system for quantifying drivers of growth of niche categories through a Market Emergence Model, in accordance with an embodiment of the present disclosure;

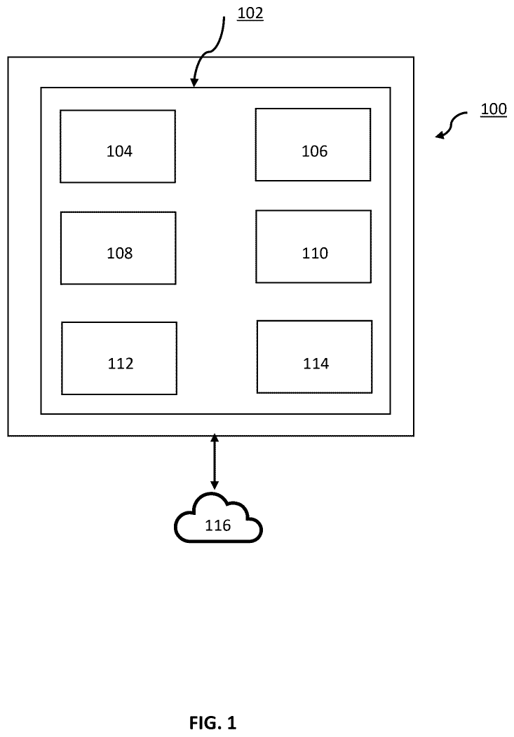

FIG. 2 is an illustration of method steps for quantifying drivers of growth of niche categories through a Market Emergence Model, in accordance with an embodiment of the present disclosure.

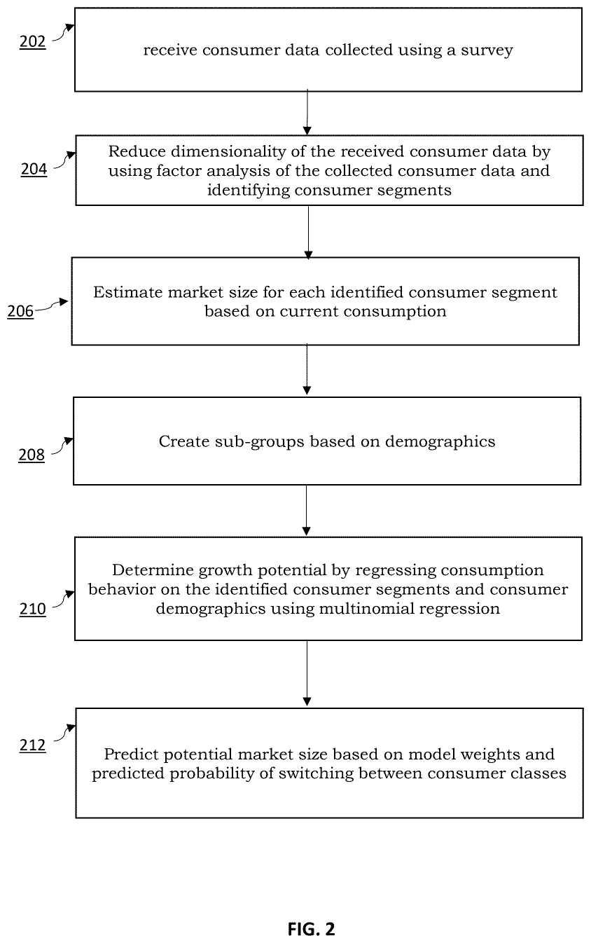

In the accompanying drawings, an underlined number is employed to represent a material over which the underlined number is positioned or a material to which the underlined number is adjacent. A non-underlined number relates to a material identified by a line linking the non-underlined number to the material. When a number is non-underlined and accompanied by an associated arrow, the nonunderlined number is used to identify a general material at which the arrow is pointing.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a system and method for quantifying growth drivers of niche categories through a Market Emergence Model (MEM). The MEM is designed to unlock the growth potential of a category by providing insights into the potential for growth, the drivers of disruptive growth, the incremental growth that can be unlocked by activating each driver, and the sources of this incremental growth.

The method disclosed involves a series of steps, beginning with receiving, by a processor, the consumer data collected through a carefully designed survey. This data collection process captures a wide range of information, including demographics, socio-economic status, consumption behavior, category perception, general psychographics, and functional and emotional needs related to the category.

Following data collection, the processor employs factor analysis to identify different consumer segments based on attitudes, functional needs, and emotional needs. The market size for each identified consumer segment is then estimated based on current consumption, and sub-groups are created based on demographics.

The method further includes using, by the processor, a growth potential determination module which determines growth potential by regressing consumption behavior on the identified consumer segments and consumer demographics using multinomial regression. This regression analysis provides model weights or coefficients and a predicted probability of switching from one consumer class to another, which are used to compute the potential market size in dollar terms.

In sum, the method disclosed herein provide a comprehensive approach to understanding and quantifying the growth potential of niche categories, offering valuable insights for brands and marketers seeking to maximize their market share and profitability.

In some aspects, the method may also involve identifying specific pathways for growth and sizing potential opportunities. These pathways may be identified through a combination of statistical analysis and market research, and may include factors such as consumer psychographics, demographics, and consumption behavior. For example, one pathway for growth might be identified as targeting a specific demographic segment with a particular marketing message, while another pathway might involve developing new products or services that cater to the functional or emotional needs of a particular consumer segment.

In some cases, the potential opportunities associated with each identified pathway may be sized using a variety of techniques. For instance, the system and method may use the model weights or coefficients derived from the multinomial regression analysis to estimate the potential market size for each pathway. This may involve calculating the predicted probability of consumers switching from one consumer class to another along each pathway, and then multiplying this probability by the estimated market size for the corresponding consumer class.

In other cases, the method may use other statistical techniques or algorithms to size the potential opportunities. For example, the method may use machine learning algorithms to predict future consumption behavior based on historical data, and then use these predictions to estimate the potential market size for each pathway.

In yet other cases, the method may use a combination of these techniques to size the potential opportunities. This may involve, for example, using the multinomial regression analysis to estimate the potential market size for each pathway, and then refining these estimates using machine learning algorithms or other statistical techniques.

In this way, the method may provide a comprehensive approach to identifying and sizing potential opportunities for growth in niche categories. This may enable brands and marketers to make more informed decisions about where to focus their resources and efforts and may ultimately lead to more effective and profitable growth strategies.

In a primary embodiment of the present disclosure, the system 100 for quantifying drivers of growth of niche categories comprises a processor 102 which further comprises a data collection module 104, an analysis module 106, a market size estimation module 108, a demographic categorization module 110, a growth potential determination module 112 and a market size prediction module 114, communicably coupled to a memory device 116.

In an aspect of the present invention, the processor 102 includes a data collection module 104 configured to receive consumer data collected through one or more surveys. The survey may be designed to administer a to a target population. The survey may be carefully designed to capture a wide range of information about the consumers, including but not limited to their demographics, socio-economic status, consumption behavior, category perception, general psychographics, and functional and emotional needs related to the category.

In some cases, the survey may include a series of questions designed to elicit specific information about the consumers. For example, the survey may include questions about the consumers' age, gender, city of residence, income level, education level, occupation, and other demographic factors. The survey may also include questions about the consumers' consumption behavior, such as their frequency of consumption, preferred brands, preferred pack size, and other consumption-related factors.

In other cases, the survey may include questions designed to capture the consumers' attitudes towards the category, their functional needs related to the category, and their emotional needs related to the category. These questions may be designed to identify latent variables or factors that influence the consumers' consumption behavior and their predisposition towards category consumption.

In yet other cases, the data collection module 104 may be configured to receive data collected from a variety of sources such as online surveys, telephone surveys, face-to-face interviews, focus groups, or other data collection methods. The data collection module 104 may also receive data collected from secondary sources, such as market research reports, industry studies, census data, or other publicly available data sources.

The collected data provides a comprehensive picture of the target population, enabling the system to identify potential growth drivers and key attitudinal segments, estimate market size, and project growth potential with a high degree of accuracy and precision.

The data received through the data analysis module 104 is high dimensional data. High-dimensional data refers to datasets with a large number of variables, or “features,” per observation. In high-dimensional spaces, the distance between data points increases, making it harder for predictive models to distinguish between relevant and irrelevant patterns. This leads to poor generalization and overfitting, where the model learns noise rather than useful patterns. As the number of dimensions increases, the volume of the space grows exponentially, and the data points become sparse. Predictive models rely on finding relationships between data points, but in high-dimensional spaces, it becomes more challenging to identify meaningful patterns as data points are spread thinly across the space. This results in poor generalization capabilities of the model. High-dimensional datasets require models to perform significantly more computations, slowing down the training and prediction processes. Each additional dimension adds complexity to the model, requiring more computational power and time, which reduces the model's practicality, especially when applied to real-time decision-making. With many features or dimensions, predictive models can easily “overfit” the training data, capturing noise or irrelevant patterns rather than the true underlying relationships. This overfitting means that the model will perform well on the training data but fail to generalize to new, unseen data. Further, higher dimensions mean that more data is needed to create a robust model. For each additional dimension, exponentially more data points are required to maintain the same level of accuracy. Without enough data, predictive models trained on high-dimensional datasets are likely to perform poorly due to insufficient coverage of the data space.

In an aspect of the present invention, the processor 102 includes an analysis module 106 configured to perform factor analysis on the received consumer data. The factor analysis may be used to identify different consumer segments based on attitudes, functional needs, and emotional needs. The factor analysis may involve identifying latent variables or factors that explain a large part of the variation observed in the data. These latent variables or factors may be used to define different consumer segments.

In some cases, the factor analysis may be performed using traditional factor analysis methods. These methods may involve constructing a correlation matrix of the variables, extracting factors from the correlation matrix, and rotating the factors to achieve a simpler and more interpretable solution. The number of factors to be extracted may be determined based on various criteria, such as the eigenvalue-greater-than-one rule, the scree plot, or the interpretability of the factors.

In other cases, the factor analysis may be performed using more advanced methods, such as principal component analysis or exploratory factor analysis. These methods may involve transforming the original variables into a new set of uncorrelated variables or factors, which are linear combinations of the original variables. The new factors may be ordered so that the first few retain most of the variation present in all of the original variables.

In yet other cases, the factor analysis may be performed using machine learning algorithms or other statistical techniques. These techniques may involve identifying patterns in the data, clustering similar data points together, and assigning each data point to a specific consumer segment.

In this way, the analysis module 106 may provide a comprehensive approach to identifying different consumer segments based on attitudes, functional needs, and emotional needs. This may enable the system to better understand the target population, identify potential growth drivers, and estimate market size with a high degree of accuracy and precision.

This approach reduces dimensionality by identifying latent variables that capture the complex relationships between consumer attitudes, functional needs, and emotional needs. By clustering consumer segments based on these latent factors, the system offers more accurate insights and predictions than traditional methods. This technical challenge of multi-dimensional consumer data is solved by transforming raw, high-dimensional data into a manageable format for use in predictive models, leading to higher accuracy in consumer segmentation and market growth predictions. It advances existing AI and ML technologies by automating and refining this data preparation process.

In another aspect of the present invention, the processor 102 further includes a market size estimation module 108 configured to estimate the market size for each identified consumer segment based on current consumption. The market size estimation module 108 may use the consumer data received by the data collection module, including data on current consumption behavior, to estimate the market size for each consumer segment.

In some cases, the market size estimation module 108 may estimate the market size by multiplying the average consumption per consumer by the number of consumers in each segment. The average consumption per consumer may be determined based on the responses to the consumption behavior questions in the survey. The number of consumers in each segment may be estimated based on the demographic data collected in the survey and the segmentation results from the factor analysis.

In other cases, the market size estimation module 108 may use more advanced statistical techniques or algorithms to estimate the market size. For example, the market size estimation module 108 may use regression analysis, machine learning algorithms, or other predictive modeling techniques to estimate the market size based on the received consumer data.

In yet other cases, the market size estimation module 108 may use a combination of these techniques to estimate the market size. This may involve, for example, using the average consumption per consumer and the number of consumers in each segment to provide an initial estimate of the market size, and then refining this estimate using regression analysis, machine learning algorithms, or other predictive modeling techniques.

In this way, the market size estimation module 108 may provide a comprehensive approach to estimating the market size for each identified consumer segment. This may enable the system to better understand the potential for growth in each segment, identify potential growth drivers, and project growth potential with a high degree of accuracy and precision.

In yet another aspect of the present invention, the processor 102 includes a demographic categorization module 110 configured to create sub-groups based on demographics. The demographic categorization module 110 may use the demographic data received by the data collection module 104 to create sub-groups. These sub-groups may be based on various demographic factors, including but not limited to age, city, and gender.

In some cases, the demographic categorization module 110 may create sub-groups based on age. The age-based sub-groups may be divided into various age ranges, such as 20-30 years, 30-40 years, 40-50 years, and 50+ years. The specific age ranges used to create the sub-groups may vary depending on the brand and category.

In other cases, the demographic categorization module 110 may create sub-groups based on city. The city-based sub-groups may be classified as urban or non-urban. The specific classification used to create the sub-groups may vary depending on the brand and category.

In yet other cases, the demographic categorization module 110 may create sub-groups based on gender. The gender-based sub-groups may be divided into male and female. The specific gender categories used to create the sub-groups may vary depending on the brand and category.

In an embodiment, the demographic categorization module 110 may create sub-groups based on a combination of age, city, and gender. This may involve creating a cross-combination of age, city, and gender to create the sub-groups. For example, one sub-group may include males aged 20-30 years living in urban areas, while another sub-group may include females aged 40-50 years living in non-urban areas.

In this way, the demographic categorization module 110 may provide a comprehensive approach to creating sub-groups based on demographics. This may enable the system to better understand the target population, identify potential growth drivers, and estimate market size with a high degree of accuracy and precision.

In another aspect of the present invention, the processor 102 includes a growth potential determination module 112 configured to determine the growth potential of each identified consumer segment. The growth potential determination module 112 may use multinomial regression to project the growth potential based on the consumption behavior of the consumers in each segment and their demographics.

In some cases, the growth potential determination module 112 may use a multinomial regression model to project the growth potential. The multinomial regression model may be based on the response variables as K levels G={1, 2, . . . , K} and X as the set of covariates. The model may be expressed as:

$$P r ( G = k \vert X = x ) = \frac{{e}^{{β}_{ok} + {β}_{k}^{T} x}}{{\sum }_{l = 1}^{k} {e}^{{β}_{ol} + {β}_{l}^{T} x}}$$

In this model, the coefficients or weights (betas) may be interpreted as odds ratios. The model may be used to compute the predicted probability of switching from one consumer class to another, which in turn may be used to compute the potential market size in dollar terms.

In other cases, the growth potential determination module 112 may use other statistical techniques or algorithms to project the growth potential. For example, the growth potential determination module 112 may use machine learning algorithms, decision tree models, or other predictive modeling techniques to project the growth potential based on the collected consumer data.

In yet other cases, the growth potential determination module 112 may use a combination of these techniques to project the growth potential. This may involve, for example, using the multinomial regression model to provide an initial projection of the growth potential, and then refining this projection using machine learning algorithms or other statistical techniques.

In this way, the growth potential determination module 112 may provide a comprehensive approach to determining the growth potential of each identified consumer segment. This may enable the system to better understand the potential for growth in each segment, identify potential growth drivers, and estimate market size with a high degree of accuracy and precision.

In yet another aspect of the present invention, the processor 102 includes a market size prediction module 114 configured to predict the potential market size based on the model weights or coefficients and the predicted probabilities of switching from one consumer class to another. The market size prediction module 114 may use the outputs of the multinomial regression analysis performed by the growth potential determination module to predict the potential market size.

In some cases, the market size prediction module 114 may compute the potential market size in dollar terms. This computation may involve multiplying the predicted probability of switching from one consumer class to another by the estimated market size for the corresponding consumer class. The estimated market size for each consumer class may be determined based on the current consumption data received by the data collection module 104 and the segmentation results from the factor analysis performed by the analysis module 106.

In other cases, the market size prediction module 114 may use other statistical techniques or algorithms to predict the potential market size. For example, the market size prediction module may use machine learning algorithms, decision tree models, or other predictive modeling techniques to predict the potential market size based on the received consumer data and the outputs of the multinomial regression analysis.

In yet other cases, the market size prediction module 114 may use a combination of these techniques to predict the potential market size. This may involve, for example, using the outputs of the multinomial regression analysis to provide an initial prediction of the potential market size, and then refining this prediction using machine learning algorithms or other statistical techniques.

In this way, the market size prediction module 114 may provide a comprehensive approach to predicting the potential market size. This may enable the system to better understand the potential for growth in each segment, identify potential growth drivers, and make more informed decisions about where to focus resources and efforts.

In some aspects, the surveys may include questions designed to capture specific psychographic factors of the consumers. These psychographic factors may provide insights into the consumers' attitudes, values, interests, and lifestyles, which may in turn influence their consumption behavior and predisposition towards category consumption. In some cases, the questions on psychographic factors may be decided by experienced market research personnel. The questions may be framed in such a way that the intent is not direct, in order to elicit more honest and accurate responses from the consumers. For example, the survey may include questions such as “I am satisfied with what I am achieving in life”, “I depend on other people more than the majority of those I know”, “If I am feeling down, I find it hard to get out of it”, and “So far, I have achieved every important goal I have set myself”. These questions may be designed to identify latent traits influencing the psychographics of the consumers.

In other cases, the survey may include questions designed to capture the consumers' predisposition towards category consumption. For example, the survey may include questions about the consumers' daily drinking habits, their reasons for drinking, their preferred drinking occasions, and their attitudes towards drinking. The responses to these questions may be used directly in the multinomial regression analysis to see if the reason for consumption varies by different consumer classes or not.

In yet other cases, the survey may include questions designed to capture the consumers' functional and emotional needs related to the category. These questions may be designed to identify the specific needs that the category fulfills for the consumers, and the emotional benefits that the consumers derive from consuming the category. For example, the survey may include questions about the consumers' need for relaxation, their need for social connection, their need for self-expression, and their need for personal gratification.

In this way, the survey may provide a comprehensive picture of the consumers' psychographic factors, predisposition towards category consumption, and functional and emotional needs related to the category. This may enable the system to better understand the target population, identify potential growth drivers, and estimate market size with a high degree of accuracy and precision.

In some aspects, the factor analysis methodology used by the analysis module 106 may involve identifying latent variables that help define different consumer segments. These latent variables may be identified based on attitudes, functional needs, and emotional needs of the consumers, as captured in the survey data. The factor analysis may involve constructing a correlation matrix of the variables, extracting factors from the correlation matrix, and rotating the factors to achieve a simpler and more interpretable solution.

In some cases, the factor analysis may be performed using traditional factor analysis methods. These methods may involve identifying the minimum number of factors or latent variables that explain a large part of the variation observed in the data. The number of factors to be extracted may be determined based on various criteria, such as the eigenvalue-greater-than-one rule, the scree plot, or the interpretability of the factors.

In other cases, the factor analysis may be performed using more advanced methods, such as principal component analysis or exploratory factor analysis. These methods may involve transforming the original variables into a new set of uncorrelated variables or factors, which are linear combinations of the original variables. The new factors may be ordered so that the first few retain most of the variation present in all of the original variables.

In yet other cases, the factor analysis may be performed using machine learning algorithms or other statistical techniques. These techniques may involve identifying patterns in the data, clustering similar data points together, and assigning each data point to a specific consumer segment.

In this way, the factor analysis methodology may provide a comprehensive approach to identifying different consumer segments based on attitudes, functional needs, and emotional needs. This may enable the system to better understand the target population, identify potential growth drivers, and estimate market size with a high degree of accuracy and precision.

In some aspects, the demographic categorization module 110 may create sub-groups based on a combination of age, city, and gender. This may involve dividing the age into various groups, such as 20-30 years, 30-40 years, 40-50 years, and 50+ years. The specific age ranges used to create the sub-groups may vary depending on the brand and category. The city may be classified as urban or non-urban, and gender may be divided into male and female. A cross-combination of age, city, and gender may be used to create the sub-groups. For instance, one sub-group may include males aged 20-30 years living in urban areas, while another sub-group may include females aged 40-50 years living in non-urban areas.

In other cases, the demographic categorization module 110 may use different demographic factors to create the sub-groups. For example, the demographic categorization module may use income level, education level, occupation, or other demographic factors to create the sub-groups. The specific demographic factors used to create the sub-groups may vary depending on the brand and category.

In yet other cases, the demographic categorization module 110 may use a combination of demographic factors and psychographic factors to create the sub-groups. This may involve, for example, creating sub-groups based on a combination of age, city, gender, and attitudes towards the category. The specific combination of factors used to create the sub-groups may vary depending on the brand and category.

In this way, the demographic categorization module 110 may provide a comprehensive approach to creating sub-groups based on demographics. This may enable the system to better understand the target population, identify potential growth drivers, and estimate market size with a high degree of accuracy and precision.

In some cases, the independent variables in the multinomial regression model may include the identified consumer segments and consumer demographics. The dependent variable may be the consumption behavior of the consumers. The coefficients or weights in the multinomial regression model may be determined based on the relationship between the independent variables and the dependent variable. For example, a positive coefficient for a particular consumer segment may indicate that consumers in that segment are more likely to increase their consumption, while a negative coefficient may indicate that consumers in that segment are less likely to increase their consumption.

In other cases, the multinomial regression model may include additional independent variables, such as the functional and emotional needs related to the category, the predisposition towards category consumption, and other factors identified through the factor analysis. These additional independent variables may provide further insights into the drivers of growth and the potential for unlocking incremental growth.

In yet other cases, the multinomial regression model may be used in conjunction with other statistical techniques or algorithms to project the growth potential. For example, the growth potential determination module may use machine learning algorithms to refine the predictions of the multinomial regression model, or to identify additional growth drivers that were not captured by the model.

In this way, the growth potential determination module 112 may provide a comprehensive approach to projecting the growth potential of each identified consumer segment. This may enable the system to better understand the potential for growth in each segment, identify potential growth drivers, and estimate market size with a high degree of accuracy and precision.

In yet other cases, the growth potential determination module 112 may use a combination of the multinomial regression model and other statistical techniques or algorithms to compute the predicted probabilities. This may involve, for example, using the multinomial regression model to provide an initial computation of the predicted probabilities, and then refining these computations using machine learning algorithms or other statistical techniques.

In this way, the growth potential determination module 112 may provide a comprehensive approach to computing the predicted probabilities of switching from one consumer class to another. This may enable the system to better understand the potential for growth in each segment, identify potential growth drivers, and estimate market size with a high degree of accuracy and precision.

In some aspects, the processor 102 may include a data cleaning and reliability check module configured to handle potential outliers or anomalies in the survey data. This module may be designed to perform various data cleaning and reliability checks to ensure the accuracy and reliability of the consumer data from surveys as received by the data collection module 104.

In some cases, the data cleaning and reliability check module may perform basic data cleaning tasks, such as removing duplicate entries, correcting inconsistent entries, and filling in missing values. These tasks may be performed using standard data cleaning techniques, such as deduplication, inconsistency correction, and imputation.

In other cases, the data cleaning and reliability check module may perform more advanced reliability checks. For example, the module may check for response bias in the survey data. If a consumer gives the same rating to all questions, it may be an indication of bias and hence the consumer's data may be removed from further analysis. This can help ensure that the survey data accurately reflects the attitudes, behaviors, and preferences of the target population, rather than being skewed by biased or unreliable responses.

In yet other cases, the data cleaning and reliability check module may use statistical techniques or machine learning algorithms to identify and handle potential outliers or anomalies in the survey data. For instance, the module may use outlier detection techniques, such as the Z-score method or the IQR method, to identify potential outliers in the data. The module may then handle these outliers using various techniques, such as winsorization, trimming, or transformation.

In this way, the data cleaning and reliability check module may provide a comprehensive approach to handling potential outliers or anomalies in the survey data. This may enable the system to ensure the accuracy and reliability of the survey data, which in turn may enhance the accuracy and precision of the subsequent analysis and predictions.

In some aspects, the processor 102 may include a validation module configured to validate the accuracy and reliability of the growth potential projections. The validation module may use statistical checks on the residuals to validate the growth potential projections. The residuals, which represent the difference between the observed and predicted values, may be analyzed to assess the goodness-of-fit of the multinomial regression model used by the growth potential determination module. For instance, the validation module may compute the standard deviation of the residuals, the mean squared error, or other statistical measures to assess the accuracy and reliability of the growth potential projections.

In some cases, the validation module may use other statistical techniques or algorithms to validate the growth potential projections. For example, the validation module may use cross-validation techniques, bootstrapping methods, or other validation techniques to assess the accuracy and reliability of the growth potential projections. These techniques may provide additional insights into the accuracy and reliability of the growth potential projections, and may help to refine the predictions of the growth potential determination module.

In yet other cases, the validation module may use a combination of statistical checks on the residuals and other statistical techniques or algorithms to validate the growth potential projections. This may involve, for example, using the statistical checks on the residuals to provide an initial validation of the growth potential projections, and then refining this validation using cross-validation techniques, bootstrapping methods, or other validation techniques.

In some aspects, the processor 102 may also include a follow-up survey module configured to account for potential changes in consumer behavior or market conditions over time. The follow-up survey module may receive updated consumer data collected using follow-up surveys conducted among the target population to capture changes in demographics, socio-economic status, consumption behavior, category perception, general psychographics, and functional and emotional needs related to the category.

In some cases, the follow-up surveys may be conducted a year or two after the initial survey. The data collected from the follow-up surveys may be used to update the consumer segments, estimate the market size, and project the growth potential. This can help ensure that the system's insights into consumer behavior and potential market size remain accurate and relevant over time.

In other cases, the follow-up survey module may use other methods to account for potential changes in consumer behavior or market conditions over time. For example, the follow-up survey module may use online tracking tools, social media analytics, or other data collection methods to capture changes in consumer behavior or market conditions over time.

In yet other cases, the follow-up survey module may receive updated consumer data using a combination of follow-up surveys and other data collection methods to account for potential changes in consumer behavior or market conditions over time. This may involve, for example, conducting follow-up surveys to capture changes in consumer behavior, and then supplementing this data with online tracking data, social media analytics, or other data sources to capture changes in market conditions.

In this way, the validation module and the follow-up survey module may provide a comprehensive approach to validating the growth potential projections and accounting for changes in consumer behavior or market conditions over time. This may enable the system to ensure the accuracy and reliability of its insights into consumer behavior and potential market size, and to adapt its growth strategies to changing market conditions.

Another embodiment of the present invention discloses a method for quantifying drivers of growth of niche categories, comprising to following method steps. At step 202, consumer data collected using a survey is received by the processor using a data collection module. At step 204, dimensionality of the received consumer data is reduced by the processor using a factor analysis of the received consumer data and identifying consumer segments. At a step 206, market size for each identified consumer segment is estimated by the processor based on current consumption. At a step 208, sub-groups are created by the processor based on demographics. At a step 210, growth potential is determined by the processor by regressing consumption behavior on the identified consumer segments and consumer demographics using multinomial regression. At a step 212, potential market size is predicted by the processor based on model weights and predicted probability of switching between consumer classes.

In some aspects, the output of the method disclosed herein may be used to inform marketing strategies and resource allocation. For instance, the identification of different consumer segments and their respective growth potentials may enable brands and marketers to tailor their marketing strategies to the specific needs and preferences of each segment. This may involve, for example, developing targeted advertising campaigns, designing new products or services, or adjusting pricing strategies to appeal to each segment.

In some cases, the method may provide insights into the predisposition towards category consumption of different consumer segments. This predisposition may be quantified through specific survey questions designed to capture the consumers' attitudes towards the category, their functional and emotional needs related to the category, and their current consumption behavior. For example, the survey may include questions about the consumers' reasons for consuming the category, their preferred brands, their preferred pack size, and other consumption-related factors. The responses to these questions may be used directly in the multinomial regression analysis to see if the reason for consumption varies by different consumer classes or not.

In other cases, the method may provide insights into the key attributes, characteristics, and demographics that move a person from a shopper to a regular, from non-triers to consider. This information may be used to inform marketing strategies aimed at converting shoppers into regular consumers, or non-triers into considerers. For example, if the method identifies that consumers in a particular age group are more likely to become regular consumers, a brand may decide to target this age group with specific marketing campaigns.

In yet other cases, the method may provide insights into the potential market size for the category from different attitudinal segments. This information may be used to inform resource allocation decisions, such as where to invest in advertising or product development. For example, if the method identifies that a particular attitudinal segment has a high growth potential, a brand may decide to allocate more resources to targeting this segment.

In this way, the method may provide valuable insights that can inform marketing strategies and resource allocation decisions, ultimately helping brands and marketers to unlock the growth potential of niche categories.

A number of implementations have been described. Nevertheless, it will be understood that various modifications may be made without departing from the spirit and scope of the disclosure. Accordingly, other implementations are within the scope of the following claims.

Various operations and methods have been described. Some methods have been described by way of flow chart in a relatively basic manner, but these operations can optionally be added to and/or removed from these methods. In addition, although the flowchart shows specific sequences of operations according to various exemplary examples, it is to be understood that the specific sequences are exemplary. Alternative examples may optionally perform these operations in different ways, combine certain operations, interlace some operations, etc. The modules, features, and specific optional details of the devices described herein may also optionally be applied to the methods described herein. In various examples, these methods may be executed by and/or executed within such devices.

In the present disclosure, respective functional parts/units/sub-units/modules/sub-modules/means may be hardware. For instance, the hardware may be a circuit including a digital circuit, an analog circuit, and the like. Physical implementation of hardware structures may include, but is not limited to, physical devices, and the physical devices may include but are not limited to transistors, memristors, and the like. The processor may be any suitable hardware processor such as a CPU, GPU, FPGA, DSP, ASIC, etc. The memory may be any suitable magnetic storage medium or magneto-optical storage medium such as RRAM, DRAM, SRAM, EDRAM, HBM, HMC, etc.

Persons skilled in the art can clearly understand that for convenience and conciseness of description, the division of the above-mentioned functional modules is illustrated only as instances, and in practical application, the above-mentioned functions can be assigned to different functional modules to complete according to the needs. In other words, the internal structure of the device can be divided into different functional modules to complete all or a part of the functions described above.

The specific examples described above further explain the purpose, technical solution, and technical effects of the present disclosure in detail. It should be understood that the above description only relates to specific examples of the present disclosure and is not intended to limit the present disclosure, and any modifications, equivalent substitutions, improvements, etc. made within the spirit and principles of the present disclosure should all be included within the scope of protection of the present disclosure.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components. A computer system can include a plurality of the components or subsystems, e.g., connected together by external interface or by an internal interface.

In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or modules or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

1. A system for quantifying drivers of growth of niche categories, comprising:
a data collection module configured to receive consumer data;
an analysis module configured to identify consumer segments in a computationally efficient manner through reducing dimensionality of received consumer data using factor analysis of the collected consumer data;
a market size estimation module configured to estimate market size for each identified consumer segment based on current consumption;
a demographic categorization module configured to create sub-groups based on demographics;
a growth potential determination module configured to determine growth potential by regressing consumption behavior on the identified consumer segments and consumer demographics using multinomial regression; and
a market size prediction module configured to predict potential market size based on model weights and predicted probability of switching between consumer classes.

2. The system of claim 1, wherein the consumer data is collected using surveys that collects data on demographics, socio-economic status, consumption behavior, category perception, general psychographics, and functional and emotional needs related to the category.

3. The system of claim 1, wherein the factor analysis identifies different consumer segments based on attitudes, functional needs, and emotional needs.

4. The system of claim 1, wherein the demographic categorization module creates sub-groups based on a combination of age, city, and gender.

5. The system of claim 1, wherein the multinomial regression uses the identified consumer segments and demographics as independent variables and consumption behavior as the dependent variable.

6. The system of claim 1, further comprising a data cleaning and reliability check module configured to handle potential outliers or anomalies in the consumer data.

7. The system of claim 6, wherein the data cleaning and reliability check module is configured to remove data from consumers who give the same rating to all questions in the survey.

8. A method for quantifying drivers of growth of niche categories, comprising:
receiving, by a processor, consumer data;
reducing dimensionality of the received consumer data by using factor analysis of the collected consumer data and identifying consumer segments;
estimating market size for each identified consumer segment based on current consumption;
creating sub-groups based on demographics;
determining growth potential by regressing consumption behavior on the identified consumer segments and consumer demographics using multinomial regression; and
predicting potential market size based on model weights and predicted probability of switching between consumer classes.

9. The method of claim 8, wherein the consumer data is collected using a survey that collects data on demographics, socio-economic status, consumption behavior, category perception, general psychographics, and functional and emotional needs related to the category.

10. The method of claim 8, wherein the factor analysis identifies different consumer segments based on attitudes, functional needs, and emotional needs.

11. The method of claim 8, wherein creating sub-groups based on demographics comprises creating sub-groups based on a combination of age, city, and gender.

12. The method of claim 8, wherein the multinomial regression uses the identified consumer segments and demographics as independent variables and consumption behavior as the dependent variable.

13. The method of claim 8, further comprising performing data cleaning and reliability checks to handle potential outliers or anomalies in the consumer data.

14. The method of claim 13, wherein performing data cleaning and reliability checks comprises removing data from consumers who give the same rating to all questions in the survey.
